(19) United States
(12) Patent Application Publication
(10) Pub. No.: US 2008/0073840 A1
(43) Pub. Date: Mar. 27, 2008

(54) SYSTEM AND METHOD FOR PROGRESSIVE JACKPOT GAMING

(76) Inventor: David Comeau, Bremerton, WA (US)

Correspondence Address: BLACK LOWE & GRAHAM, PLLC, 701 FIFTH AVENUE, SUITE 4800, SEATTLE, WA, 98104, US

(21) Appl. No.: 11/861,919

(22) Filed: Sep. 26, 2007

Related U.S. Application Data
(60) Provisional application No. 60/827,058, filed on Sep. 27, 2006.

(51) Int. Cl. G06F 19/00; A63B 71/00; A63F 1/00

(52) U.S. Cl. 273/138.1; 463/27; 273/292

(57) ABSTRACT

Systems and methods for progressive jackpot gaming are disclosed herein. A method for progressive jackpot gaming includes betting on the outcome of a card game. All bets in the card game are placed in a community pot. The card game is played to completion. Once the card game is completed a winner of the card game is determined. The community pot is paid to the winner of the game and a rake placed in the jackpot. A bonus is then paid from a jackpot if a player has a bonus eligible hand, a portion of the jackpot may be paid to one or more players even if they are not the winner of the hand.

### PRIORITY CLAIM

This application claims the benefit of U.S. Provisional Application Ser. No. 60/827,058 filed on Sep. 27, 2006, and is herein incorporated by reference in its entirety.

### FIELD OF THE INVENTION

This invention relates generally to card games and, more specifically, to a method of playing a card game with a progressive jackpot.

### BACKGROUND OF THE INVENTION

Texas Hold 'Em is the most popular poker variant played in casinos in the United States. In contrast to poker games like Stud or Draw where each player holds a separate individual hand, Hold 'Em is a community card game where each player may use any combination of the five community cards and their own two hole cards to make a poker hand.

After slow but steady gains in popularity throughout the 20th century, Hold 'Em's popularity surged after 2000 due to exposure on television, the Internet and in popular literature. During this time Hold 'Em replaced 7 card Stud as the most common game in U.S. casinos, almost totally eclipsing the once popular game. The no-limit betting form is used in the widely televised main event of the World Series of Poker (WSOP) and the World Poker Tour (WPT).

Because each player starts with only two cards and the remaining cards are shared, it presents an opportune game for strategic analysis (including mathematical analysis).

Like all variants of poker, in Texas Hold 'Em individuals compete for an amount of money contributed by the players themselves (called the pot). Because the cards are dealt randomly and outside the control of the players, each player attempts to control the amount of money in the pot based on the hands they hold.

The game is divided into a series of hands or deals, at the conclusion of each hand the pot is awarded to one or a few players. A hand ends either at the showdown (when the remaining players compare their hands), or when all but one player have folded and abandoned their claim to the pot. The pot is then awarded to the players who have not folded and have the best hand. (This is usually only one player, but can be more in the case of a tie.)

The objective of winning players is not winning every individual hand, but rather making mathematically correct decisions. By making such decisions, winning poker players maximize their long run winnings, which are achieved by maximizing their expected utility on each round of betting.

Hold 'Em is normally played using small and big blind bets-forced bets by two players. Antes (forced contributions by all players) may be used in addition to blinds, particularly in later stages of tournament play. A dealer button is used to represent the player in the dealer position; the dealer button rotates clockwise after each hand, changing the position of the dealer and blinds. The small blind is posted by the player to the left of the dealer and is usually equal to half of the big blind. The big blind, posted by the player to the left of the small blind, is equal to the minimum bet. In tournament poker, the blind/ante structure periodically increases as the tournament progresses.

When only two players remain, special ‘head-to-head’ or ‘heads up’ rules are enforced and the blinds are posted differently. In this case, the person with the dealer button posts the small blind, while his/her opponent places the big blind. The dealer acts first before the flop. After the flop, the dealer acts last for the remainder of the hand.

### SUMMARY OF THE INVENTION

Systems and methods for progressive jackpot gaming are disclosed herein. A method for progressive jackpot gaming includes betting on the outcome of a card game. All bets in the card game are placed in a community pot. The card game is played to completion. Once the card game is completed a winner of the card game is determined. The community pot is paid to the winner of the game and a rake placed in the jackpot. A bonus is then paid from a jackpot if a player has a bonus eligible hand, a portion of the jackpot may be paid to one or more players even if they are not the winner of the hand.

### BRIEF DESCRIPTION OF THE DRAWINGS

The preferred and alternative embodiments of the present invention are described in detail below with reference to the following drawings:

FIG. 1 is a schematic view of an exemplary operating environment in which an embodiment of the invention can be implemented;

FIG. 2 is a functional block diagram of an exemplary operating environment in which an embodiment of the invention can be implemented; and

FIG. 3 shows a method of progressive jackpot gaming.

### DETAILED DESCRIPTION OF THE PREFERRED EMBODIMENT

Systems and methods for progressive jackpot gaming are disclosed herein. When players are at a gaming table, whether physical or virtual, and while a game is in progress, those people are betting on their cards. Assuming that all of the bets are collected in a central pot, as the players play and bet the pot begins to grow. In order to facilitate a progressive jackpot, it is preferable to take a small amount of money from each individual pot to fund the progressive jackpot. Jackpot and Bonus pots are used herein to describe funds containing money to be distributed to a player if they obtain a particular hand. In an alternate embodiment, the jackpot may include non-money items including but not limited to points, comps and/or anything of perceived value to a player. When a player hits a specific hand, the player would receive a portion of the progressive jackpot. In one embodiment, a jackpot hand would include at least one of the players “hole cards”. A list of possible hands include, but are not limited to: a royal flush, a straight flush, a daily double, four aces, four kings, four queens, four jacks, four tens, four nines, four eights, four sevens, four sixes, four fives, four fours, four threes, and/or four twos. The progressive jackpot may be used in a physical game or through a game using software.

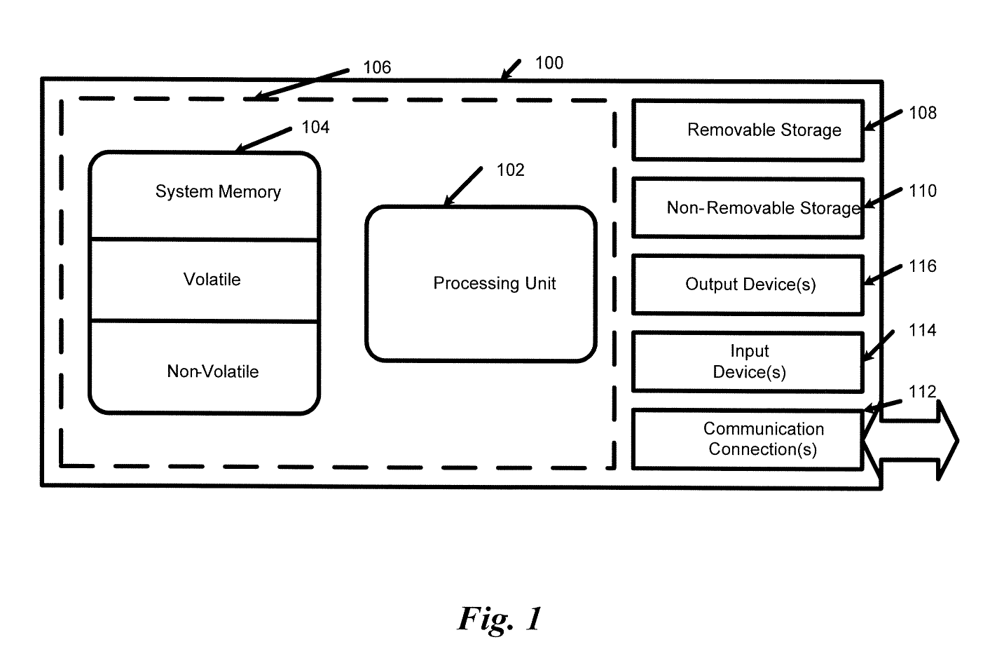

FIG. 1 illustrates an example of a computing system environment 100 on which an embodiment of the invention may be implemented. The computing system environment 100, as illustrated, is an example of a suitable computing environment; however, it is appreciated that other environments, systems, and devices may be used to implement various embodiments of the invention as described in more detail below.

Embodiments of the invention are operational with numerous other general purpose or special purpose computing system environments or configurations. Examples of well-known computing systems, environments and/or configurations that may be suitable for use with embodiments of the invention include, but are not limited to, personal computers, server computers, hand-held or laptop devices, PDAs, multiprocessor systems, microprocessor-based systems, set-top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer. Generally, program modules include routines, programs, objects, components, data structures, etc. that performs particular tasks or implement particular abstract data types. Embodiments of the invention may also be practiced in distributed-computing environments where tasks are performed by remote processing devices that are linked through a communications network, for example, over an intranet or the Internet. In a distributed computing environment, program modules may be located in both local and remote computer storage media including memory storage devices.

With reference to FIG. 1, an exemplary system for implementing an embodiment of the invention includes a computing device, such as computing device 100. The computing device 100 typically includes at least one processing unit 102 and memory 104. Depending on the configuration and type of computing device, memory 104 may be volatile (such as random-access memory (RAM)), nonvolatile (such as read-only memory (ROM), flash memory, etc.) or some combination of the two. This most basic configuration is illustrated in FIG. 1 by dashed line 106.

Additionally, the device 100 may have additional features, aspects, and functionality. For example, the device 100 may include additional storage (removable and/or non-removable) that may take the form of, but is not limited to, magnetic or optical disks or tapes. Such additional storage is illustrated in FIG. 1 by removable storage 108 and non-removable storage 110. Computer storage media includes volatile and nonvolatile, removable and non-removable media implemented in any method or technology for storage of information such as computer-readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 100. Any such computer storage media may be part of device 100.

The device 100 may also contain a communications connection 112 that allows the device to communicate with other devices. The communications connection 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, the communication media includes wired media such as a wired network or direct-wired connection, and wireless media such as acoustic, radio frequency (RF), infrared and other wireless media. The term computer-readable media as used herein includes both storage media and communication media.

The device 100 may also have an input device 114 such as keyboard, mouse, pen, voice-input device, touch-input device, etc. Further, an output device 116 such as a display, speakers, printer, etc. may also be included. Additional input devices 114 and output devices 116 may be included depending on a desired functionality of the device 100.

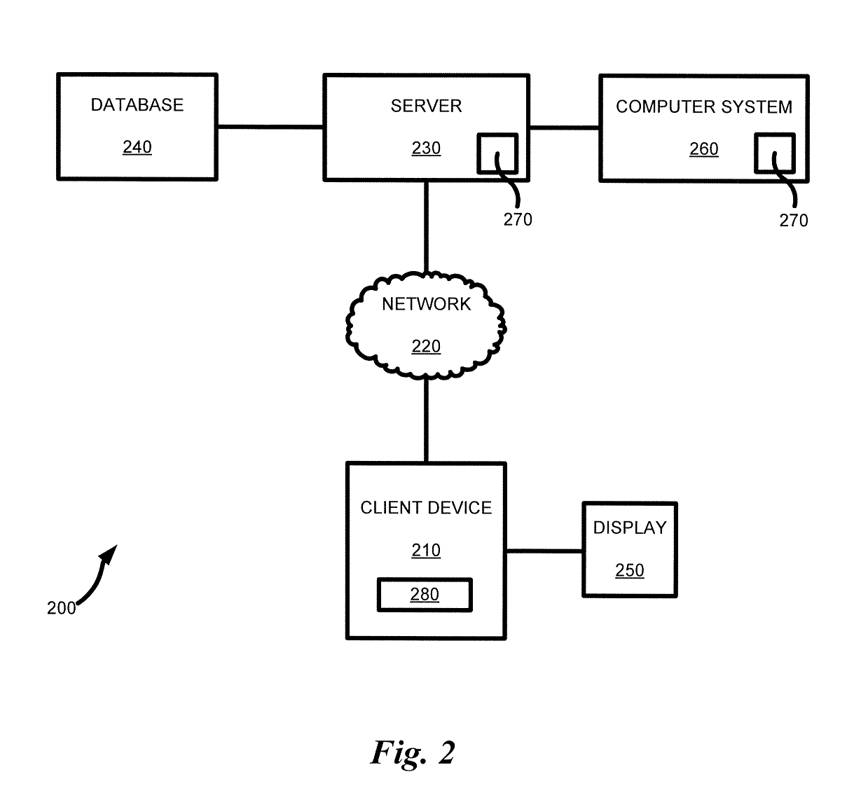

Referring now to FIG. 2, an embodiment of the present invention takes the form of an exemplary computer network system 200. The system 200 includes an electronic client device 210, such as a personal computer or workstation, that is linked via a communication medium, such as a network 220 (e.g., the Internet), to an electronic device or system, such as a server 230. The server 230 may further be coupled, or otherwise have access, to a database 240 and a computer system 260. Although the embodiment illustrated in FIG. 2 includes one server 230 coupled to one client device 210 via the network 220, it should be recognized that embodiments of the invention may be implemented using one or more such client devices coupled to one or more such servers.

The client device 210 and the server 230 may include all or fewer than all of the features associated with the device 100 illustrated in and discussed with reference to FIG. 1. The client device 210 preferably includes or is otherwise coupled to a computer screen or display 250. The client device 210 may be used for various purposes such as network- and local-computing processes.

The client device 210 is linked via the network 220 to server 230 so that computer programs, such as, for example, a browser, running on the client device 210, can cooperate in two-way communication with server 230. The server 230 may be coupled to database 240 to retrieve information therefrom and to store information thereto. Database 240 may include a plurality of different tables (not shown) that can be used by the server 230 to enable performance of various aspects of embodiments of the invention. Additionally, the server 230 may be coupled to the computer system 260 in a manner allowing the server to delegate certain processing functions to the computer system.

Still referring to FIG. 2, and in operation according to an embodiment of the invention, a user (not shown) of the client device 210 desiring to play a card game with a progressive jackpot uses a browser application running on the client device to access web content served by the server 230.

Still referring to FIG. 2, and in operation according to an embodiment of the invention, a user (not shown) of the client device 210 desiring to play a card game with a progressive jackpot application running on the client device to access web content, which may, but need not, be served by the server 230. Specifically, by employing an appropriate uniform resource locator (URL) in a known manner, the user may download from the server 230 and install on the client device 210 a user interface module 280 comprising computer-executable instructions as described more fully hereinafter. Alternatively, the user may receive the module 280 on a tangible computer-readable medium (not shown), such as, for example, a CD-ROM, and subsequently install the module on the client device 210 from the medium. When playing with online software, the progressive jackpot will accrue after every game is dealt. When a player achieves a desired hand, the jackpot will be automatically credited to their account.

The game will be described as applied both to all participants as well as to a single participant. It is understood that game play described with reference to a single participant is equally applicable to the game play of any number of similarly situated participants.

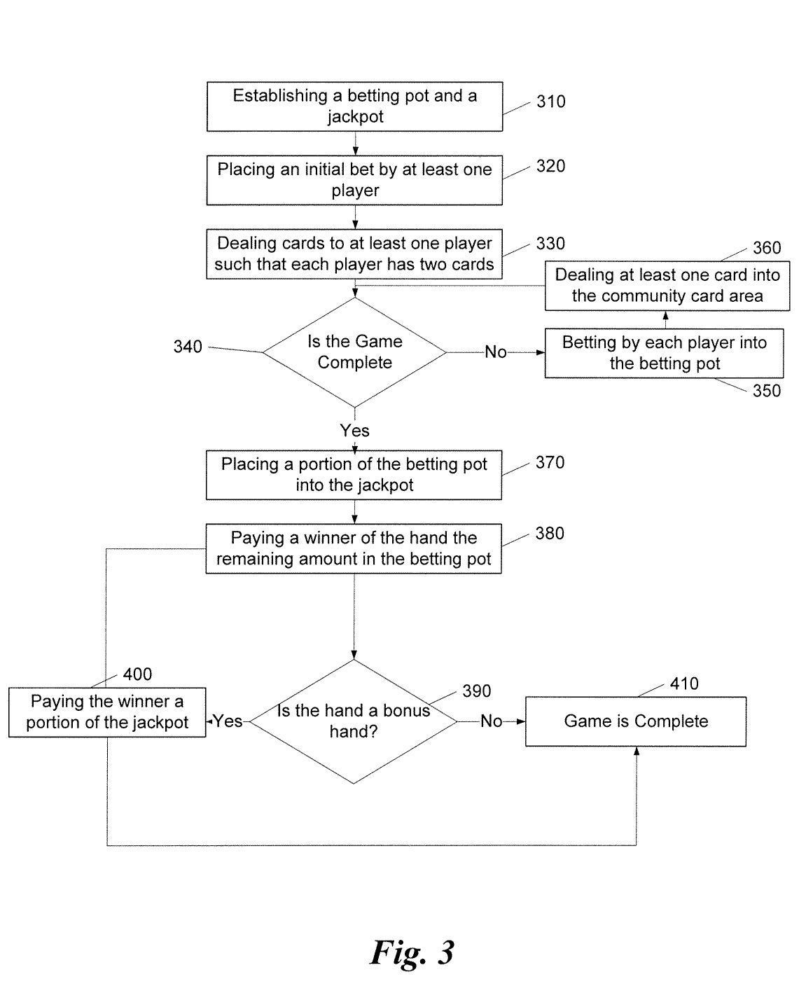

FIG. 3 shows a method for progressive jackpot gaming. In this example, the betting game is Texas Hold 'Em. This game may be played as computer software or at a physical gaming table. At block 310 a jackpot and a betting pot are established. At block 320 the players place their initial bets into the betting pot. In one embodiment, this includes “blind” bets. At block 330, cards are dealt to each player such that each player has two cards. At decision block 340, a determination is made to decide if the game is complete. If not, at block 350, each player bets into the betting pot to stay in the game or folds to quit. At block 360 the dealer deals at least one additional card into the community cards. The method then returns to block 340 until the game is complete. If the game is complete then at block 370 a portion of the pot is placed into the jackpot; this portion is otherwise known as a rake. In one embodiment, a rake is taken for the house or company at this step. In an alternate embodiment, the jackpot is funded by another source. At block 380 the winner is paid the remaining money in the pot. At decision block 390 the winner's hand is compared to the bonus hand. If the hand is a bonus hand, the logic proceeds to block 400, where the player is paid a portion of the jackpot. If the hand is not a bonus hand, then the game is complete at block 410.

In one embodiment when a portion of the pot is placed in a jackpot, a rake, the money optionally can be divided into percentages based on each type of bonus hand. For example, 15% of the rake may be placed in a jackpot for a royal flush, 10% for Quad aces until 100% of the rake has been allocated. In an alternate embodiment, a player having an eligible hand for a bonus takes a percentage of the total pot based on each type of bonus hand. For example 15% of the jackpot is paid for a royal flush, or for example 10% is paid for Quad aces.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is: claimed are defined as follows:

1. A method for progressive jackpot gaming comprising:
betting on the outcome of a card game such that all bets are placed in a pot;
playing the card game to completion;
determining the winner of the card game;
paying a bonus from a jackpot to a player when the player has a bonus eligible hand;
withholding a rake from the pot in order to fund the jackpot; and
distributing the remaining pot to the winner of the game.

2. The method of claim 1 wherein the card game is Texas Hold 'Em.

3. The method of claim 2 wherein the bonus eligible hand comprises at least one of a royal flush, a straight flush, a daily double, four aces, four kings, four queens, four jacks, four tens, four nines, four eights, four sevens, four sixes, four fives, four fours, four threes, and four twos.

4. A system for progressive jackpot gaming comprising:
a memory configured to store jackpot information;
a display; and
a processor in data communication with the display and the memory, the processor comprising:
a first component configured to receive betting information from at least one player playing a card game;
a second component configured to execute the card game to completion;
a third component configured to determine a winner of the card game; and
a fourth component configured to pay a bonus from a jackpot to a player when the player has a bonus eligible hand;
a fifth component configured to withhold a rake from the pot in order to fund the jackpot; and
a sixth component configured to distribute the remaining pot to the winner of the game.

5. The system of claim 4 wherein the card game is Texas Hold'Em.

6. The system of claim 5 wherein the bonus eligible hand comprises at least one of a royal flush, a straight flush, a daily double, four aces, four kings, four queens, four jacks, four tens, four nines, four eights, four sevens, four sixes, four fives, four fours, four threes, and four twos.
